(19) United States
(12) Patent Application Publication
(10) Pub. No.: US 2009/0039076 A1
(43) Pub. Date: Feb. 12, 2009

(54) Multi-Compartment Microwaveable Food Container

(76) Inventors: Albert Vincent Maslowski, Palatine, IL (US); Leonard S. Scarola, Basking Ridge, NJ (US)

Correspondence Address: FITCH EVEN TABIN & FLANNERY, 120 S. LASALLE STREET, SUITE 1600, CHICAGO, IL, 60603-3406, US

(21) Appl. No.: 11/836,598

(22) Filed: Aug. 9, 2007

(51) Int. Cl. H05B 6/80

(52) U.S. Cl. 219/729; 219/734

(57) ABSTRACT

A multi-compartment microwaveable food container and, in particular, a microwaveable container having at least two compartments with different degrees of shielding to provide different energy inputs to food products contained therein while being heated in a microwave together at the same settings. At least one compartment of the container contains an in-mold label or other type of shielding with microwave-reflective areas to provide the desired shielding properties to the food product contained therein. Additionally, a lid component can also contain an in-mold label or other type of shielding to provide further shielding of the compartment. The two or more food compartments may contain various degrees of shielding provided by complete or partial in-mold labels or other types of shielding.

### FIELD

A multi-compartment microwaveable food container adapted for modifying microwave energy, and in particular a microwaveable food container having at least two separate compartments adapted for differently modifying microwave energy to food products contained in the different compartments.

### BACKGROUND

Two or more different food items are often packaged together in the same container and then frozen, refrigerated or shelf-stabilized before use. The frozen food package can then be reheated together in a microwave to thaw the food items and bring them to a preferred consumption temperature. Different frozen, refrigerated or shelf-stable foods that are packaged together often require different energies, or differential energy inputs, to reheat the food items in the microwave prior to consumption, however, despite this differential energy the foods often receive the same amount of energy when placed in the microwave together resulting in one or more food items being overcooked or undercooked. Typically the first and second food products have different energy requirements when cooking or heating, such that if both food products are placed in a microwave for the same amount of time at the same temperature at least one food product may be overcooked while the other may be undercooked. For example, if stored in a frozen condition, one food product may thaw faster than another food product and once thawed that food product continues to cook and receive more energy, and thus cook faster than the other food product, resulting in non-uniform cooking of the two food products. To solve this problem where two or more different food items are to be simultaneously heated in a microwave and one food item requires more heat than another food item, a shielding and/or susceptor material has been used.

Multi-component containers are known that store two or more different food items and allow for sections of the container to be exposed to microwave energy while shielding other sections from the microwave energy, where the different sections correspond to the different food requirements. Various shielding techniques are known that shield or prevent microwave energy from heating one food item, while allowing microwave energy to heat another food item in the same package. In U.S. Pat. No. 5,416,304, one such shielding apparatus is used with a frozen pizza, where the shield is in the shape of a ring and is wrapped around the periphery of the pizza to help provide an improved uniformity of cooking, whereas without the shield the crust could possibly overcook, since it thaws before the rest of the pizza and then continues to absorb energy at a higher rate than the rest of the frozen pizza. Another shielding technique is disclosed in U.S. Pat. No. 4,874,618, where a shield shaped like a sleeve fits around a cup-like container which contains ice cream and a sauce or other food item to be warmed or heated. The sleeve is fitted such that it only shields the ice cream part of the container during microwave heating, keeping the ice cream frozen while allowing the sauce or other food item to be heated. Another similar ice cream container is disclosed in U.S. Pat. No. 4,934,829, where a container with an ice cream and a food item to be heated is wrapped along the outside of the container with a shield, such as aluminum foil. The foil wrapping covers the top and sides, stopping just short of the bottom of the container where the food item to be heated is located, thus allowing the bottom portion to be heated while keeping the ice cream from being heated. However, all of these shielding techniques require an extra piece or separate part to be included with the container as the shield and are not easily manufactured in a continuous, commercial process.

Furthermore, when a frozen, refrigerated or shelf-stable food product like a sandwich is to be reheated in a microwave where the multiple food items make up the whole of the product, there is no simple method to reheat the product. One such attempt to heat a sandwich product is disclosed in U.S. Pat. No. 5,416,305, where a package for a sandwich separates the bread from the non-bread (i.e., the fillings of a sandwich) portion so that upon reheating the frozen sandwich, the non-bread container can be removed to allow only heating of the bread component. This can create two heating steps if the non-bread component is also required to be heated, as well as requiring a further step to reheat the bread component if it has cooled off while heating the non-bread component.

There are other multi-component containers that can contain a susceptor zone, which is a zone that absorbs microwave energy, or both a susceptor zone and a shielding zone. U.S. Pat. No. 6,903,320 discloses a multi-component molded microwaveable container having at least two sections, where at least one section has an in-mold label with a susceptor zone. This container can similarly be used for an ice cream food product and a cake or sauce. The container can also include a shielding zone, such that either a single in-mold label is used that provides both a susceptor zone and a shielding zone, or more than one in-mold label is used where each label provides a separate zone function.

### SUMMARY

A multi-component microwaveable container is provided with one or more shields, such as an in-mold label, for shielding one or more food compartments from microwave energy while placed in a microwave. Two or more different food items can be stored in the at least two food compartments, where one or more compartments may be shielded with an in-mold label, while a part of at least another compartment is unshielded and thus allowed to be heated by the microwave energy.

The multi-component microwaveable container can contain at least two separate compartments for storing at least two different food items in a freezer, refrigerator or shelf until consumption. A first food item may require less energy input than a second food item to prepare it in a microwave. Therefore, a first compartment that stores the first food item may receive a different, or lower, percentage of the microwave energy incident on the outer surface of the compartment such that both food substances reach their preferred consumable temperature after the same amount of time in the microwave. The differential energy input can be achieved via shielding. The shielding may be applied to the container in a variety of manners, including in-mold or otherwise. The shielding may be included with a label or other applied substrate. The shielding may also be applied, such as by print, directly on the container. Furthermore, the shielding may vary in coverage or function. For instance, the shielding may be in a pattern that includes non-shielded areas or may be applied in different thicknesses.

### BRIEF DESCRIPTION OF THE DRAWINGS

FIG. 1 is a perspective view of a first embodiment of a multi-compartment microwaveable food container;

FIG. 2 is a side perspective view of the microwaveable container of FIG. 1;

FIG. 3 is a top perspective view of the microwaveable container of FIG. 1;

FIG. 4 is a cross-sectional view taken along line 4-4 of FIG. 1 and showing a first and a second compartment of the container;

FIG. 5 is an exploded view of the microwaveable container of FIG. 1;

FIG. 6 is a perspective view of a second embodiment of a multi-compartment microwaveable food container;

FIG. 7 is a side perspective view of the microwaveable container of FIG. 6;

FIG. 8 is a perspective view of the opened microwaveable container showing a first and a second compartment; and

FIG. 9 is a cross-sectional view taken along line 9-9 of FIG. 7 and showing the first and the second compartment of the container in the closed position;

FIG. 10 is a detailed view of the closing mechanism of the container as shown in FIG. 9;

FIG. 11 is an exploded view of the microwaveable container of FIG. 6;

FIG. 12 is a perspective view of a third embodiment of a multi-compartment microwaveable food container;

FIG. 13 is a perspective view of the opened microwaveable container of FIG. 12;

FIG. 15 is a cross-sectional view taken along line 15-15 of FIG. 13;

FIG. 16 a perspective view of a fourth embodiment of a multi-compartment microwaveable food container;

FIG. 17 is a side perspective view of the microwaveable container of FIG. 16;

FIG. 18 is an exploded view of the microwaveable container of FIG. 16;

FIG. 19 is a perspective view of a fifth embodiment of a multi-compartment microwaveable food container;

FIG. 20 is a top perspective view of the microwaveable container of FIG. 19;

FIG. 21 is a side perspective view of the microwaveable container of FIG. 19;

FIG. 22 is an exploded view of the microwaveable container of FIG. 19;

FIG. 23 is a cross-sectional view taken along line 23-23 of the microwaveable container of FIG. 21; and

FIGS. 24A-C are process line schematics of the manufacture of a microwaveable container of any of the above embodiments.

### DETAILED DESCRIPTION

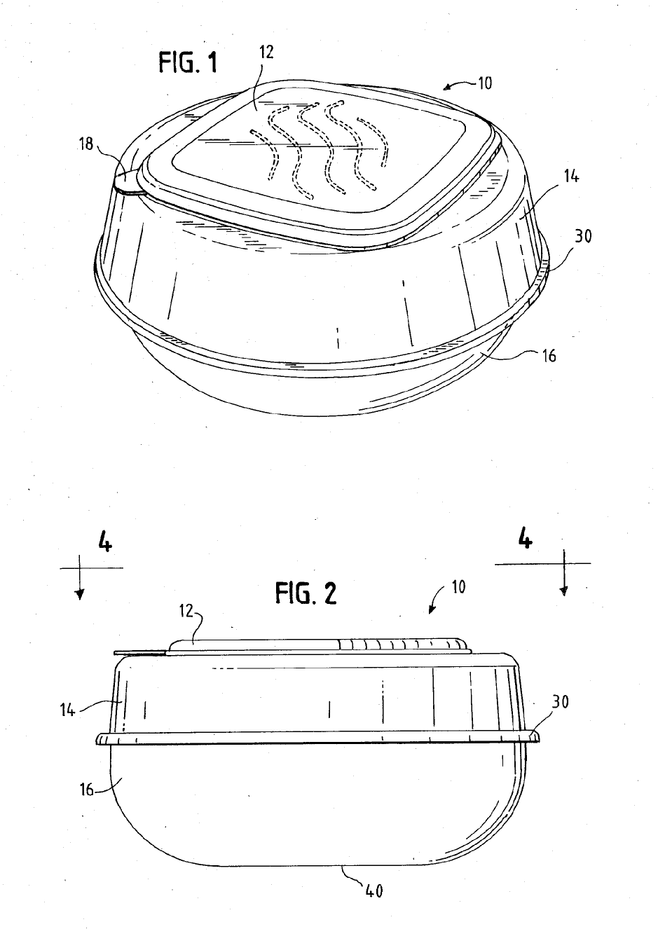

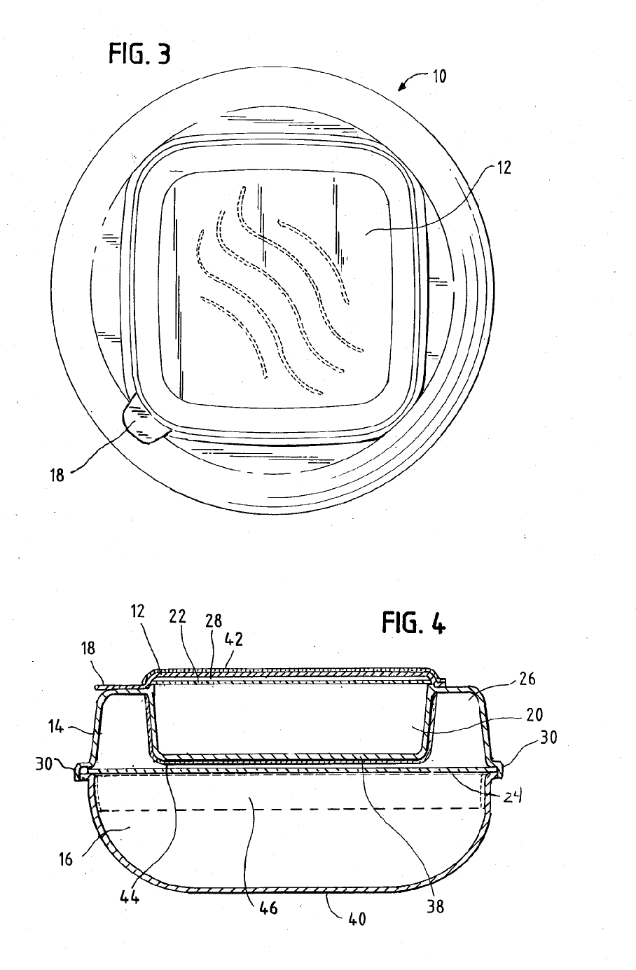

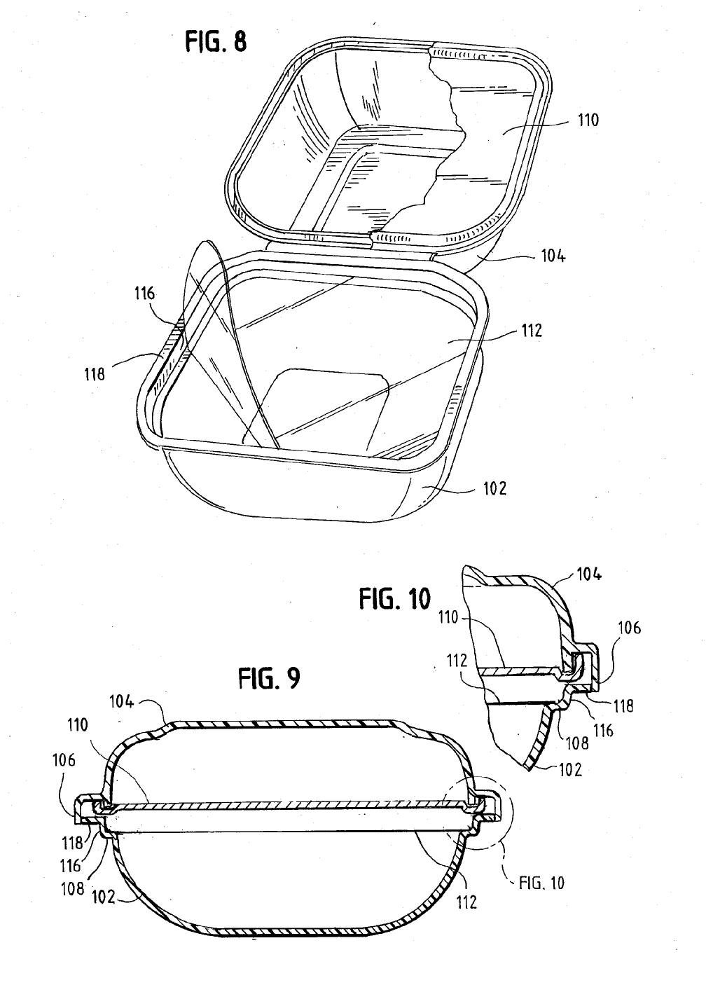

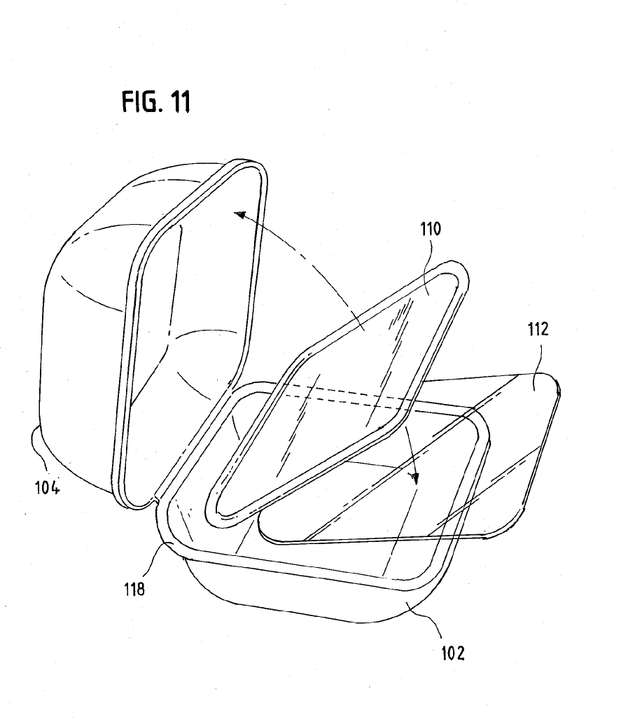

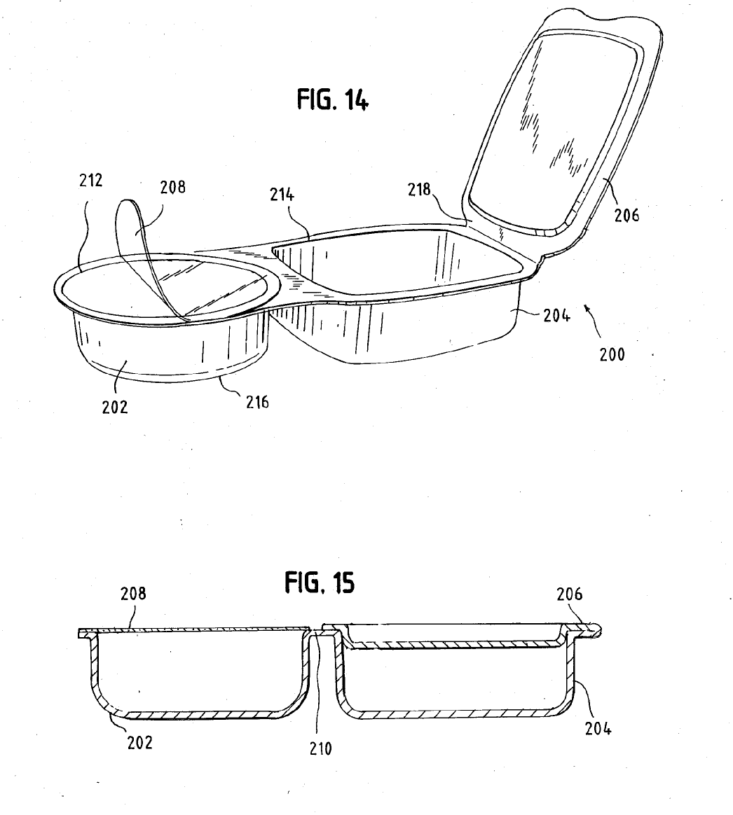

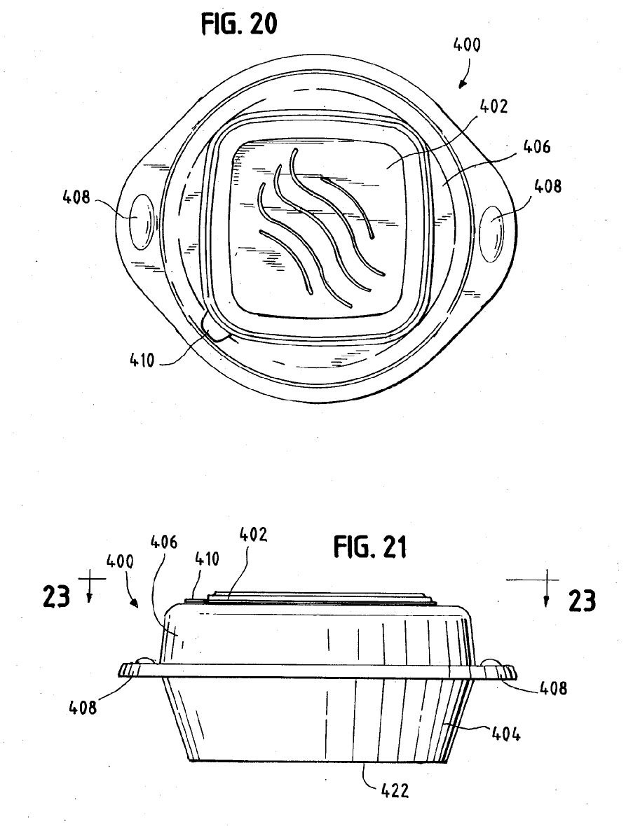

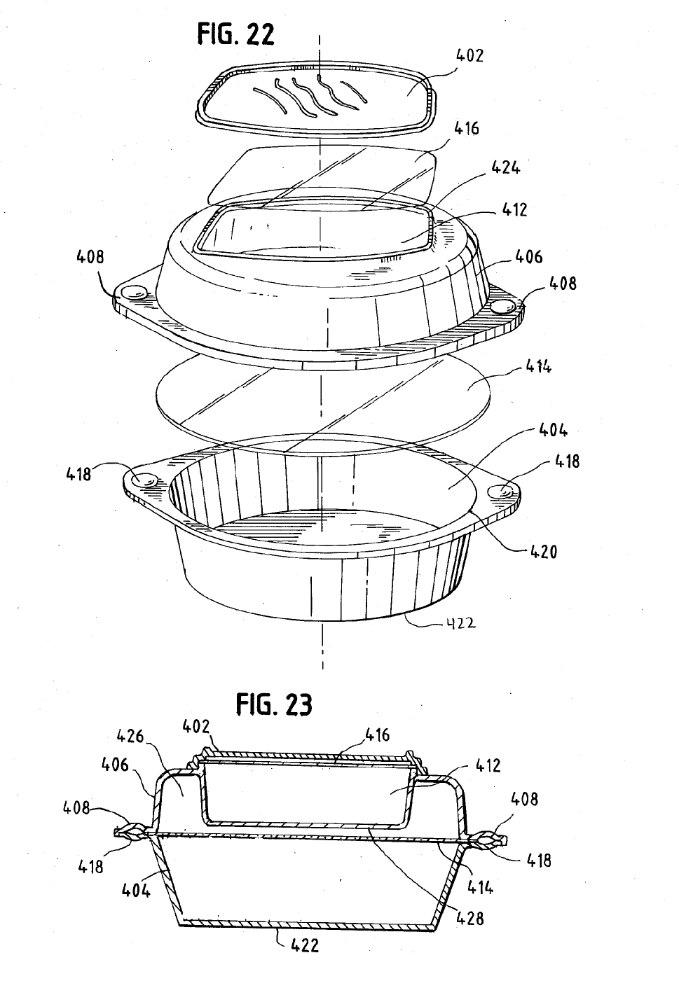

A multi-compartment microwaveable food container and, in particular, microwaveable containers having at least two compartments with different degrees of shielding to provide different energy inputs to food products contained therein as it is being heated in a microwave, are disclosed herein and illustrated in FIGS. 1-24. In particular, at least one compartment contains an in-mold label or otherwise applied shield disposed thereat having microwave-reflective properties to shield that portion of the compartment that is adjacent the shield. Additionally, a portion of the lid of the container or shielded compartment may also contain an in-mold label to provide shielding to the compartment contained beneath that portion of the lid. The shielding of certain portions of the container or certain compartments allows for one or more food products to be stored in the container and cooked in the microwave oven together, while providing varying degrees of microwave energy to the food product relative to the amount of energy needed to cook or maintain the temperature of the food product.

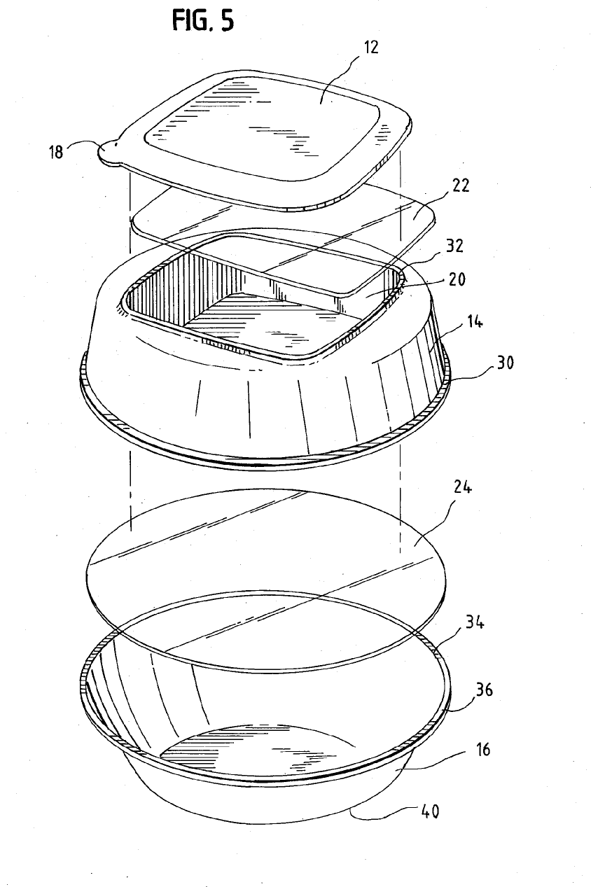

Referring to FIGS. 1-5, a first embodiment is shown of a cooking apparatus, or food container, for use in microwave cooking of a food product. The container 10 comprises a first compartment 16 and a second compartment 20, as shown in FIGS. 4 and 5, where the second compartment 20 is arranged in a stacked configuration with the first compartment 16. For example, the second compartment 20 may be positioned above or on top of the first compartment 16, when the container 10 is placed in an upright position such that it rests on the bottom edge 40 of the first compartment 16, however, other arrangements of the compartments is possible, such that the second compartment 20 is below the first compartment 16. Alternatively, the first compartment 16 and the second compartment 20 can be arranged in a side-by-side configuration.

The first compartment 16 may consist of the larger of the two compartments, however, the opposite may also be true. The first compartment 16 may have a rounded, or generally bowl-shaped configuration, one that is more convenient for holding a liquid food product, such as a soup. The first compartment 16 may have a bottom edge 40 that rounds upwards into side edges, with the top section having an opening 34. The opening 34 of the first compartment 16 can be covered with a film layer 24 to enclose the first compartment 16 and can further be covered with a lid 14. The lid 14 of the first compartment 16 can be configured such that it does not rest substantially adjacent the film 24 or opening 34 of the first compartment 16, but rather is raised above the opening 34 to provide an interior space 26 therein.

The second compartment 20 may be smaller than the first compartment 16, and can have a bottom edge 38 and side edges, preferably in a generally rectilinear configuration, with the top section having an opening 32, that defines the upper perimeter of the second compartment 20. The second compartment 20 may also have a film layer 22 disposed on its opening 32 to enclose the second compartment 20. The second compartment 20 can also have a lid 12 disposed on the opening 32 of the second compartment 20, and is adjacent to the film 22, if one is present. There can be a minimal space 28 provided between the lid 12 and the film 22 of the second compartment 20. Preferably, the second compartment 20 will rest substantially below the upper section of the lid 14 of the first compartment 16 such that the second compartment 20 is substantially contained within the interior space 26 of the lid 14 of the first compartment 16. The bottom edge 38 of the second compartment 20 is slightly suspended above the opening 34 of the first compartment 16 and above the upper surface of the film layer 24, if a film 24 is present. The shape of the second compartment 20 is preferably such that it compliments the shape of the second food product contained therein, such that if a sandwich is stored therein, for example, and the sandwich is square or rectangular, so is the shape of the second compartment 20.

The first compartment 16 contains a first food product and the second compartment 20 contains a second food product, where both food products are initially in a frozen state prior to heating or cooking in the microwave and where each has a different energy input for heating to a consumption temperature. In order to provide a more uniform cooking result and to allow the food products to cook together at the same microwave incident energy for the same amount of time, the food product which requires a lower amount of energy can be shielded such that it receives less energy than the other food product. This can be done by providing for an in-mold label having microwave-reflective areas disposed in a part of the container corresponding to preselected areas that provide shielded zones to the food product requiring less energy and unshielded or partially shielded zones to the food product requiring a greater amount of energy. The in-mold label with microwave-reflection may be disposed on at least one of the compartments, either the first or the second, and can be disposed on the lid 12 of the second compartment 20. The in-mold label of at least one of the compartments can be disposed on an outside, intermediate, or inner layer of the outside layer of the compartment, an intermediate layer of the compartment or on an inner layer of the compartment. The in-mold label may similarly be disposed on an outside, intermediate, or inner layer of the lid 12 of the second compartment 20. Furthermore, the in-mold label may completely encircle a perimeter of the compartment or may only partially encircle it. Additionally, the lid 14 of the second compartment 20 may be partially or completely shielded as well, depending upon the requirements of the first food product in the first compartment 16. Types of suitable shielding for this and other embodiments disclosed herein, and suitable methods of application to the containers, are disclosed in PCT publications WO2005/068321 and WO2003/043474, the disclosures of which are hereby incorporated by reference in their entireties. Alternatively, a label that is not an in-mold label or another type of shielding may be utilized, and can be utilized in the other embodiments discussed herein.

For example, the first food product that is enclosed in the first compartment 16 can comprise a liquid food product, such as a soup, that tends to require a greater amount of energy to bring the first food product from a relatively frozen state to that of a liquid state. Therefore, little or no shielding of the first compartment 16 is necessary to provide the desired cooking results of the first food product. On the other hand, the second food product that is enclosed in the second compartment 20 can comprise a non-liquid food product, or a bread-based food product such as a sandwich, that tends to require a lesser amount of energy to bring the bread and its fillings from a frozen state to that of a preferable warm temperature for consumption. As a result, less microwave energy is needed, thus requiring more shielding of the second compartment 20 to prevent a large amount of energy from penetrating into the second compartment 20.

To achieve the desired shielding of the compartments such that the liquid product of the first compartment 16 is liquefied, and the non-liquid food product of the second compartment 20 is warmed, only certain parts of the container 10 are shielded corresponding to the compartments and the food products therein. For instance, the lid 12 of the first compartment 16 can contain an in-mold label 42 with microwave-reflection positioned substantially throughout the entire lid 12, so that it covers the second compartment 20 and provides a shielded zone. The second compartment 20 can also contain an in-mold label 44 with microwave-reflection surrounding the perimeter of the second compartment 20, such that when a food product is placed therein, the combination of the shielding of the lid 12 and the second compartment 20 provide for relatively complete shielding of the second food product.

The first compartment 16 requires less shielding than the second compartment 20 and as a result only a portion of the first compartment 16 may contain an in-mold label 46 with microwave-reflection, if at all. Generally, an in-mold label 46 will be shaped to wrap around an upper perimeter of the first compartment 16, much like a band, to provide shielding only to the upper portion of the compartment 16, but allowing microwave energy to penetrate through the bottom 40 and un-shielded sides of the first compartment 16. Alternatively, the in-mold label 46 may be positioned around a lower perimeter of the first compartment or may partially wrap around the first compartment 16 such that there are windows or gaps of un-shielded areas to provide the desired amount of microwave energy to the product inside. Optionally, it may be desirable to not have any shielding of the first compartment 16, and as a result it would not contain any shielding disposed thereat.

Tabs or protruding edges can be provided to further assist in opening the container 10. For example, the lid 12 covering the second compartment 20 can be provided with a small corner tab 18 which extends slightly beyond a corner perimeter of the second compartment 20 resting slightly above the upper surface of the lid 14 of the first compartment 16, thus allowing the user some space to grasp the tab 18 and pull upwards. Additionally, the lid 14 of the first compartment 16 can contain a protruding rim 30 at the lower perimeter of the lid 14, which mates with a flange 36 of the first compartment 16 and can also be easily grasped and pulled apart from the flange 36 to open the first compartment 16.

Any arrangement of the compartments and food products is possible, for example, instead of the second compartment 20 being stacked on top of the first compartment 16, the opposite configuration may also be true. Furthermore, instead of the shielded food product being located in the second compartment 20, it may be located in the first compartment 16 with substantial shielding of the first compartment 16 and minimal shielding of the second 20. Additionally, more than two food products may be used and more than two stacked compartments may be used.

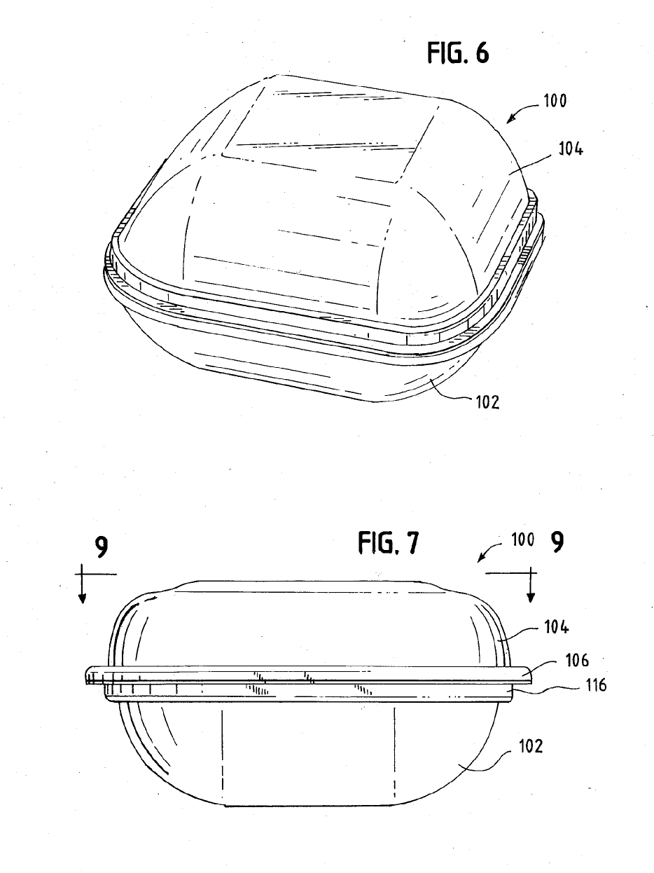

Referring to FIGS. 6-11, a second embodiment is shown of a cooking apparatus, or food container, for use in microwave cooking of a food product. The container 100 comprises a first compartment 102 and a second compartment 104, where the first compartment 102 and the second compartment 104 are in a stacked configuration, as shown in FIGS. 6 and 7. For example, the first compartment 102 can be positioned below the second compartment 104 in the stacked configuration, however, other arrangements of the compartments is possible, such that the second compartment 104 is below the first compartment 102. Alternatively, the first compartment 102 and the second compartment 104 can be arranged in a side-by-side configuration.

The first compartment 102 can comprise a bowl and the second compartment 104 can comprise an inverted bowl that is configured to mate with the bowl of the first compartment 102. For example, the first compartment 102 can have a rectilinear recess 108 therein with an upstanding wall 116 and flange 118 about the perimeter of the first compartment 102. The flange 118 receives a part of a film layer 112 which encloses the first compartment 102. To close the container 100, the second compartment 104 can fit over the first compartment 102 and locks together where an outer rim 106 of the second compartment 104 mates with the flange 118 of the first compartment 102.

The first 102 compartment can generally be larger than the second compartment 104, however the opposite may also be true. The first compartment 102 and the second compartment 104 can also be connected by a hinged common edge. The opening of the first compartment 102 can be covered with a film layer 112 to enclose the first compartment 102. Likewise, the opening of the second compartment 104 can also be covered with a film layer 110 to enclose the second compartment 104, however the second compartment 104 will preferably be covered by a lid 110.

The first compartment 102 contains a first food product and the second compartment 104 contains a second food product, where both food products are initially in a frozen state prior to heating or cooking in the microwave. In order to provide a more uniform cooking result and to allow the food products to cook together at the same microwave incident energy for the same amount of time, the container 100 can be shielded in certain areas. This can be done by providing for an in-mold label having microwave-reflective areas disposed in a part of the container corresponding to preselected areas to provide shielded zones to certain food products. The in-mold label (or other type of shield) with microwave-reflection may be disposed on at least one of the compartments, either the first or the second, and can be disposed on the lid 110 of the second compartment 104. The in-mold label of at least one of the compartments can be disposed on the outside layer of the compartment, an intermediate layer of the compartment or on an inner layer of the compartment. The in-mold label may similarly be disposed on an outside, intermediate or inner layer of the lid 110. Preferably, the in-mold label will be disposed at the second compartment 104, such that together with shielding of the lid 110, a relatively shielded compartment is provided. Furthermore, the in-mold label may completely encircle a perimeter of the second compartment 104 or may only partially encircle it; likewise with the lid 110. In addition or instead of applied shielding, the food product may also function as a shield.

For example, the first food product that is enclosed in the first compartment 102 can comprise a liquid food product, such as a soup, that tends to require a greater amount of energy to bring the first food product from a relatively frozen state to that of a liquid state. Therefore, little or no shielding of the first compartment 102 is necessary to provide the desired cooking results of the first food product. On the other hand, the second food product that is enclosed in the second compartment 104 can comprise a non-liquid food product, or a bread-based food product such as a sandwich, that tends to require a lesser amount of energy, hence more shielding of the second compartment 20 is needed.

To achieve the desired shielding of the compartments such that the liquid product of the first compartment is liquefied, and the non-liquid food product of the second compartment is warmed, only certain parts of the container are shielded corresponding to the compartments and the food products therein. For instance, the second compartment 104 can be substantially completely shielded by providing an in-mold label disposed at the outer walls of the second compartment 104 and an in-mold label disposed at the lid 110.

The first compartment 102 requires less shielding than the second compartment 104 and as a result only a portion of the first compartment 102 may contain an in-mold label with microwave-reflection, if at all. For example, an in-mold label that encircles an upper diameter portion of the first compartment 102 may be provided, such as in the first embodiment, or any other type of partial shielding. Optionally, it may be desirable to not have any shielding of the first compartment 102, and as a result it may not contain any in-mold labels disposed thereat. Also, in addition to or instead of shielding, one of the compartments may be thermally insulated from the other compartment(s).

Any arrangement of the compartments and food products is possible, for example, instead of the second compartment 104 being stacked above the first compartment 102, the opposite configuration may be true. Furthermore, instead of the shielded food product being located in the second compartment 104, it may be located in the first compartment 102 with substantial shielding of the first compartment 102 and minimal shielding of the second 104. Additionally, more than two food products may be used and more than two stacked compartments may be used.

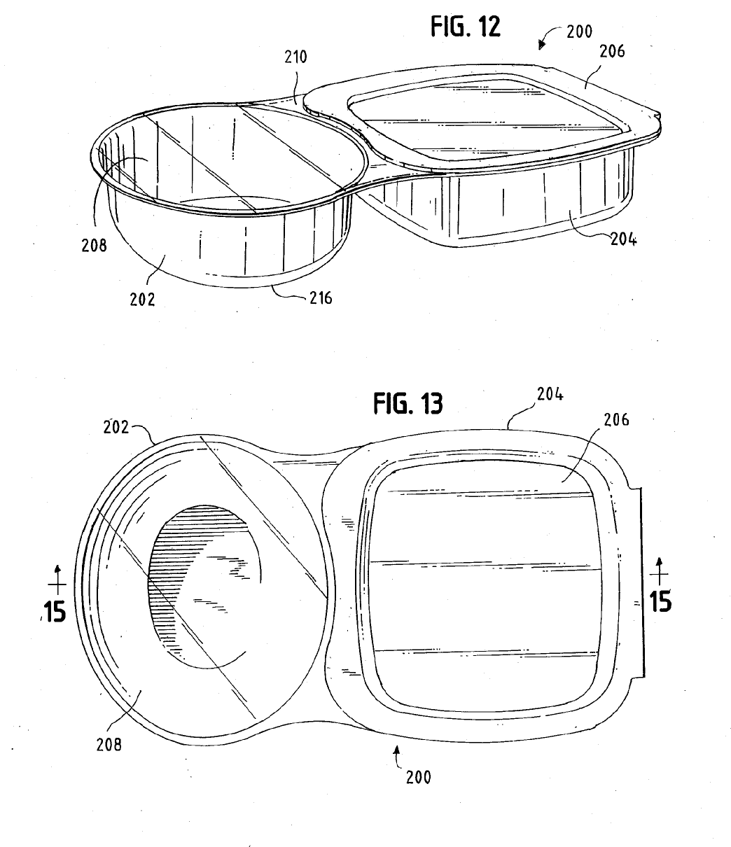

Referring to FIGS. 12-15, a third embodiment is shown of a cooking apparatus, or food container, for use in microwave cooking of a food product. The container 200 comprises a first compartment 202 and a second compartment 204, as shown in FIG. 12, arranged in a side-by-side configuration. For example, the first compartment 202 and the second compartment 204 may be attached along a common edge or flanged section 210 such that both compartments are in the same plane. Preferably, the flanged section 210 would be along the two longest edges of each compartment, however, any other two edges can be attached.

The first compartment 202 may have a rounded, or generally bowl-shaped configuration, one that is more convenient for holding a liquid food product, such as soup. The first compartment 202 may have a bottom edge 216 that rounds upwards into side edges, with the top section having an opening 212 defining the perimeter of the first compartment 202. The opening 212 of the first compartment 202 can be covered with a film layer 208 to enclose the first compartment 202.

The second compartment 204 may have a generally rectilinear configuration with the top section having an opening 214 that also defines the perimeter of the second compartment 204. The second compartment 204 can have a lid 206 disposed on the second compartment 204 and covering the opening 214. The second compartment 204 may also optionally include a film layer disposed over its opening 214 and underneath the lid 206, to enclose the second compartment 204. The shape of the second compartment 204 is preferably such that it compliments the shape of the second food product contained therein, such that if a sandwich is the second food product, for example, and the sandwich is square or rectangular, the shape of the second compartment 204 will be also.

The first compartment 202 contains a first food product and the second compartment 204 contains a second food product, where both food products are initially in a frozen state prior to heating or cooking in the microwave. In order to provide a more uniform cooking result and to allow the food products to cook together at the same microwave incident energy for the same amount of time, the container 200 may be partially shielded with at least one in-mold label with microwave-reflection disposed thereat. The in-mold label with microwave-reflection may be disposed on at least one of the compartments, either the first or the second, and can also be disposed on the lid 206. The in-mold label of at least one of the compartments can be disposed on the outside layer of the compartment, an intermediate layer of the compartment or on an inner layer of the compartment. Furthermore, the in-mold label may completely encircle a perimeter of the compartment or may only partially cover the compartment.

For example, the first food product that is enclosed in the first compartment 202 can comprise a liquid food product, such as a soup, that tends to require a greater amount of energy to bring the first food product from a relatively frozen state to that of a liquid state. Therefore, little or no shielding of the first compartment 202 is necessary to provide the desired cooking results of the first food product. On the other hand, the second food product that is enclosed in the second compartment 204 can comprise a non-liquid food product, or a bread-based food product such as a sandwich, that tends to require a lesser amount of energy to bring the bread and its fillings from a frozen state to that of a preferable temperature for consumption. As a result, less microwave energy is needed, thus requiring more shielding of the second compartment 204 to prevent a large amount of energy from penetrating into the second compartment 204.

To achieve the desired shielding of the compartments such that the liquid product of the first compartment 202 is liquefied, and the non-liquid food product of the second compartment 204 is warmed, only certain parts of the container 200 are shielded corresponding to the compartments and the food products therein. For instance, the lid 206 of the second compartment 204 can contain an in-mold label with microwave-reflection positioned substantially throughout the entire lid 206, so that it covers the second compartment 204 and provides a shielded zone. The second compartment 204 can also contain an in-mold label with microwave-reflection surrounding the perimeter of the second compartment 204, such that when a food product is placed therein, the combination of the shielding of the lid 206 and the second compartment 204 provide for relatively complete shielding of the second food product.

The first compartment 202 requires less shielding than the second compartment 204 and as a result only a portion of the first compartment 202 may contain an in-mold label with microwave-reflection, if at all. Generally, an in-mold label will be shaped to wrap around an upper perimeter, or diameter, of the first compartment 202, much like a band, to provide shielding only to the upper portion of the compartment 202, but still allowing microwave energy to penetrate through the bottom 216 and un-shielded sides of the first compartment 202. Alternatively, the in-mold label may be placed at any other location on the first compartment 202 or may be a partial label such that it provides shielded zones only in certain spots. Optionally, it may be desirable to not have any shielding of the first compartment 202, and as a result it would not contain any in-mold labels disposed thereat.

To open the container 200 and to gain access to the food products enclosed therein, the film layer 208 covering the first compartment 202 can be peeled back to reveal the opening 212 of the first compartment 202 and the lid 206 covering the second compartment 204 can also be opened by lifting the lid 206. The lid 206 may be attached to the second compartment 204 by a hinge 218 at one of the outer edges of the compartment 204. Alternatively, the lid 206 may not be attached by a hinge at all or may be attached at any edge. If a film layer is also attached beneath the lid 206, then this additional film layer can also be removed to gain access to the food product in the second compartment 204.

Any arrangement of the compartments and food products is possible, for example, both compartments may include lids, or only the first compartment instead of the second compartment may contain a lid. Furthermore, instead of the shielded food product being located in the second compartment 204, it may be located in the first compartment 202 with substantial shielding of the first compartment 202 and minimal shielding of the second 204. Additionally, more than two food products may be used and more than two compartments may be included.

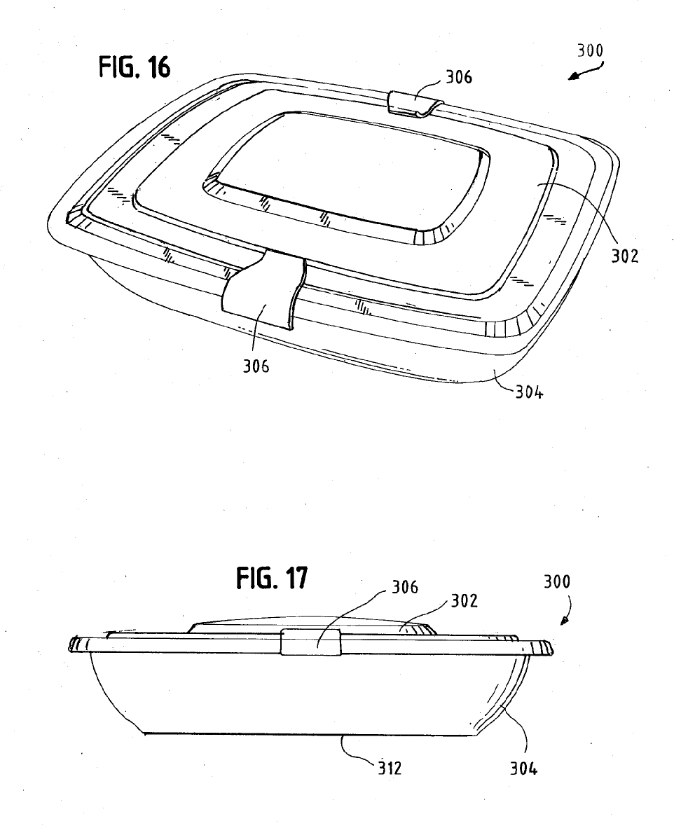

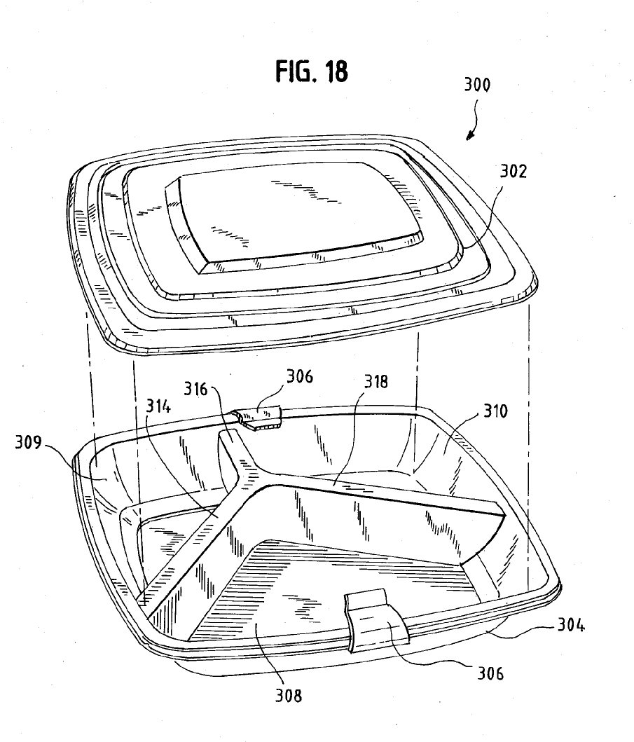

Referring to FIGS. 16-18, a fourth embodiment is shown of a cooking apparatus, or food container, for use in microwave cooking of a food product. The container 300 can comprise multiple interior compartments, such as, for example, a first compartment 308, a second compartment 309, and a third compartment 310, as shown in FIG. 18, and all contained in a base 304 of the container 300. Each of the compartments 308, 309, and 310 has a bottom edge 312, at least one outer side edge that is part of the base 304, and at least one inner side edge that is shaped between a compartment. The multiple compartments 308, 309, and 310 can be arranged in a side-by-side configuration, whereas, for example, the first 308 and second 309 compartments share at least one common interior wall 314, the second 309 and third 310 compartments share a different common interior wall 316, and the third 310 and first 308 compartments share still a different common interior wall 318.

The first compartment 308 may be generally larger in size than the second and third compartments, or they may all have generally the same size. However, any combination of compartment sizes is possible, such that the second compartment may be larger than the first and third compartments, and so on. The shapes of the individual compartments can be any shape that is convenient for the food product to be stored therein, and may be generally rectilinear or triangular. The shape of the base 304 of the container 300 can be any shape and can be dictated by the arrangement and shapes of the compartments, but is preferably rectilinear. The bottom 312 of the base 304 may be generally flat or rounded, but preferably shaped so that the container 300 can stand on its bottom edge 312. The compartments 308, 309, and 310 all can have a common lid 302 disposed on the compartments 308, 309, and 310 to enclose it, and the lid 302 can also be rectilinear in shape to match the shape of the base 304 of the container 300. Alternatively, each compartment 308, 309, and 310 can have its own individual lid or any other similar variations. Optionally, the openings of one or more compartments can be covered with a film layer to further enclose the compartments.

The first compartment 308 contains a first food product, the second compartment 309 contains a second food product, and the third compartment 310 contains a third food product, where all of the food products are initially in a frozen state prior to heating or cooking in the microwave and each food product may require a different amount of energy to bring the food product to a desired temperature for consumption. In order to provide a more uniform cooking result and to allow the food products to cook together at the same microwave incident energy for the same amount of time, the container 300 may be partially shielded with at least one in-mold label with microwave-reflection. This can be done by providing for an in-mold label having microwave-reflective areas disposed in a part of the container 300 corresponding to preselected areas such that it provides shielded zones to the food product requiring less energy and less shielding to the food products requiring greater energy. The in-mold label with microwave-reflection may be disposed on at least one of the compartments 308, 309, and 310 and can also be disposed on at least a portion of the lid 302. The in-mold label of at least one of the compartments can be disposed on the outside layer of the compartment, an intermediate layer of the compartment or on an inner layer of the compartment. Furthermore, the in-mold label may completely encircle a perimeter of the compartment or may only partially encircle the compartment.

For example, the first food product that is enclosed in the first compartment 308 can comprise a liquid food product, such as a soup, that tends to require a greater amount of energy to bring the first food product from a relatively frozen state to that of a liquid state. Therefore, little or no shielding of the first compartment 308 would be necessary to provide the desired cooking results of the first food product. On the other hand, the second food product that is enclosed in the second compartment 309 can comprise a non-liquid food product, or a bread-based food product such as a sandwich, that tends to require less energy to bring the bread and its fillings from a frozen state to that of a warm temperature for consumption. As a result, less microwave energy is desired for the second food product which in turn means more shielding of the second compartment 309. Finally, the third food product may comprise a frozen dessert or ice cream product that is consumed in a relatively frozen or cold state, such that little to no energy is desired in the third compartment 310 and therefore the shielding of the third compartment 310 is substantially throughout the entire compartment 310.

To achieve the desired shielding of the compartments such that the liquid product of the first compartment 308 is liquefied, the non-liquid food product of the second compartment 309 is warmed, and the dessert product of the third compartment 310 is kept cold, only certain parts of the container 300 are shielded corresponding to the compartments and the food products therein. For instance, the lid 302 may contain a partial in-mold label with microwave-reflection positioned so that it covers the intended compartments, providing a shielded zone to those compartments, and does not cover certain other compartments or portions thereof. Similarly, all, none or some of the side walls of the compartments 308, 309, and 310 may contain shielding with an in-mold label, as well as a portion of the bottom wall corresponding to the desired compartment to shield. For example, the third compartment 310 containing a frozen dessert may be completely shielded by containing an in-mold label disposed on the container 300, at the side walls and bottom edge of the third compartment 310, such that it substantially completely surrounds the third compartment 310. Furthermore, the portion of the lid 302 that is directly overhead of the third compartment may also contain a portion of an in-mold label such that it shields the third compartment 310 from the top. Similarly, the first 308 and second 309 compartments may contain in-mold labels to provide some degree of shielding to the respective compartments as is desired for the food product contained therein, or they may not contain any in-mold labels. Shielding may optionally be placed on the divider or sidewalls between compartments, or portions thereof.

To open the container 300 and to gain access to the food products enclosed therein, the lid 302 covering the base 304 of the container 300 can be removed to gain access to the food products therein. To open the lid 302 typically a locking device, or lid clips 306, may need to be removed. Lid clips 306 may be provided along opposing sides of the container 300, and clip to a portion of the base 304 and an opposing portion of the lid 302 to hold the base 304 and lid 302 locked in place. At least one lid clip 306 can be used, but as many as are necessary can be provided to keep the container 300 closed and the lid 302 in place during storage and microwave use. The lid 302 may also alternatively be attached to a portion of the base 304 by a hinge at at least one of the side edges at a periphery of the base 304. Optionally, a film layer may also be disposed over part of or all of the compartments.

Any arrangement of the compartments and food products is possible, for example, all of the compartments may be shielded or two may be shielded and a third unshielded, or any other feasible combinations. Additionally, more than three food products may be used and more than three compartments may be included.

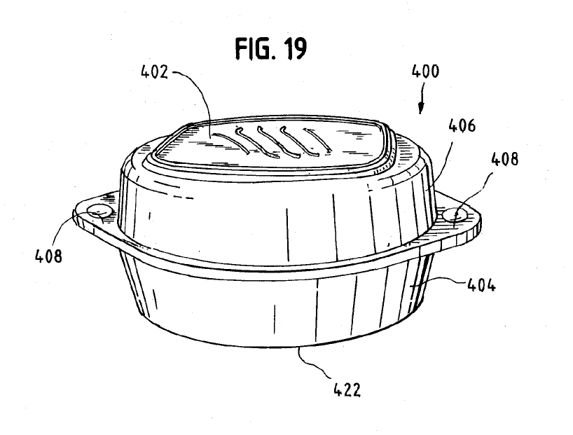

Referring to FIGS. 19-23, a fifth embodiment is shown of a cooking apparatus, or food container, for use in microwave cooking of a food product. The container 400 comprises a first compartment 404 and a second compartment 412, where the second compartment 412 can be arranged in a stacked configuration with the first compartment 404. For example, the second compartment 412 may be positioned above or on top of the first compartment 404, when the container 400 is placed upright such that it rests on the bottom edge 422 of the first compartment 404, however, other arrangements of the compartments is possible, such as the second compartment 412 being below the first compartment 404, and other variations. Alternatively, the first compartment 404 and the second compartment 412 can be arranged in a side-by-side configuration.

The first compartment 404 may consist of the larger of the two compartments, however, the opposite may also be true. The first compartment 404 may have a relatively flat bottom edge 422 with generally circular shaped side edges, and a top section having an opening 420. The opening 420 of the first compartment 404 can be covered with a film layer 414 to enclose the first compartment 404 and can further be covered with a lid 406. The lid 406 of the first compartment 404 can be configured such that it does not rest substantially adjacent the film 414 or opening 420 of the first compartment 404, but rather is raised up above the opening 420 to provide an interior space 426 therein.

The second compartment 412 may be smaller than the first compartment 404, and can have a bottom edge 428 and side edges, preferably in a generally rectilinear configuration, with the top section having an opening 424. Alternatively, the second compartment 412 may be circular or any other shape that is convenient for storing a food product therein. The second compartment 412 may also have a film layer 416 disposed on its opening 424 to enclose the second compartment 412. The second compartment 412 can also have a lid 402 disposed on the opening 424 of the second compartment 412, and is adjacent to the film 416, if one is present. Preferably, the second compartment 412 will rest substantially below the upper section of the lid 406 of the first compartment 404 such that the second compartment 412 is substantially contained within the interior space 426 of the lid 406 of the first compartment 404. The bottom edge 428 of the second compartment 412 is slightly suspended above the opening 420 of the first compartment 404 and above the upper surface of the film layer 414, if a film is present. The shape of the second compartment 412 is preferably such that it compliments the shape of the food product contained therein, such that if a sandwich is stored therein, for example, and the sandwich is square or rectangular, so is the shape of the second compartment 412.

The first compartment 404 contains a first food product and the second compartment 412 contains a second food product, where both food products are initially in a frozen state prior to heating or cooking in the microwave. In order to provide a more uniform cooking result and to allow the food products to cook together at the same microwave incident energy for the same amount of time, the container 400 can be shielded. This can be done by providing for an in-mold label having microwave-reflective areas disposed in a part of the container 400 corresponding to preselected areas such that it provides shielded zones to the food product requiring less energy and unshielded or partially shielded zones to the food product requiring a greater amount of energy. The in-mold label with microwave-reflection may be disposed on at least one of the compartments and can also be disposed on the lid 402 of the second compartment 412. The in-mold label of at least one of the compartments can be disposed on the outside layer of the compartment, an intermediate layer of the compartment or on an inner layer of the compartment. The in-mold label may similarly be disposed on an outside, an intermediate, or an inner layer of the lid 402 of the second compartment 412. Furthermore, the in-mold label may completely encircle a perimeter of the compartment or may only partially encircle it.

For example, the first food product that is enclosed in the first compartment 404 can comprise a liquid food product, such as a soup, that tends to require a greater amount of energy to bring the first food product from a relatively frozen state to that of a liquid state. Therefore, little or no shielding of the first compartment 404 is necessary to provide the desired cooking results of the first food product. On the other hand, the second food product that is enclosed in the second compartment 412 can comprise a non-liquid food product, or a bread-based food product such as a sandwich, that tends to require less energy to bring the bread and its fillings from a frozen state to that of a warm temperature for consumption. As a result, less microwave energy is desired in the second compartment 412, which in turn means more shielding of the second compartment 412.

To achieve the desired shielding of the compartments such that the liquid product of the first compartment 404 is liquefied, and the non-liquid food product of the second compartment 412 is warmed, only certain parts of the container 400 are shielded corresponding to the compartments and the food products therein. For instance, the lid 402 can contain an in-mold label with microwave-reflection positioned substantially throughout the entire lid 402, so that it covers the second compartment 412 and provides a shielded zone. The second compartment 412 can also contain an in-mold label with microwave-reflection surrounding the perimeter of the second compartment 412, such that when a food product is placed therein, the combination of the shielding of the lid 402 and the shielding of the second compartment 412 provide for relatively complete shielding of the second food product.

The first compartment 404 requires less shielding than the second compartment 412 and as a result only a portion of the first compartment 404 may contain an in-mold label with microwave-reflection, if at all. Generally, an in-mold label will be shaped to wrap around an upper perimeter of the first compartment 404, much like a band, to provide shielding only to the upper portion of the compartment 404, but allowing microwave energy to penetrate through the bottom 422 and the portion of the un-shielded sides of the first compartment 404. Alternatively, the in-mold label may be positioned around a lower perimeter of the first compartment 404 or may partially wrap around the first compartment 404 such that there are windows or gaps of un-shielded areas to provide the desired amount of microwave energy to the product inside. Optionally, it may be desirable to not have any shielding of the first compartment 404, and as a result it would not contain any in-mold labels disposed thereat.

Tabs or protruding edges can be provided in the container 400 that can assist in opening. For example, the lid 406 of the first compartment 404 can contain a protruding tab 408 at the lower perimeter of the lid 406 which mates with flanges 418 of the first compartment 404 and can be easily grasped and pulled apart from the flanges 418 to open the first compartment 404, however, other variations may be utilized. Optionally, the lid 402 covering the second compartment 412 can be provided with a small corner tab, or other protruding edge, which would extend slightly beyond a perimeter of the second compartment 412 to provide a user with an easy open tab. Alternatively, one or both lids may be attached to its respective compartments by a hinged common edge.

Any arrangement of the compartments and food products is possible, for example, instead of the second compartment 412 being stacked on top of the first compartment 404, the opposite configuration may be true. Furthermore, instead of the shielded food product being located in the second compartment 412, it may be located in the first compartment 404 with substantial shielding of the first compartment 404 and minimal shielding of the second 412, or any other variations thereof. Additionally, more than two food products may be used and more than two stacked compartments may be used.

The food products that can be stored in the containers are all initially in a frozen state, but can be in any state preferable for consumption at room temperature. For example, food products can be consumed in a liquid state (i.e., melted or thawed in the container) or can even remain in a relatively frozen state after heating, for consumption. Possible food combinations in multi-compartment microwaveable containers may comprise such food combinations as crackers and cheese dip, a container with different compartments having different types of nuts which require different energy inputs, popcorn and soy nuts, a soup and a sandwich, a brownie and a whipped cream, a brownie and ice cream, chili with cheese and sour cream, soup and uncooked bread, sandwich and cottage cheese, vegetables and entrees (such as chicken breast, pasta, etc.), dipping sauce and pizza, macaroni and cheese, cooked bun and hot dog, and within one compartment foods such as caramel or chocolate in cookies, and a grilled cheese sandwich.

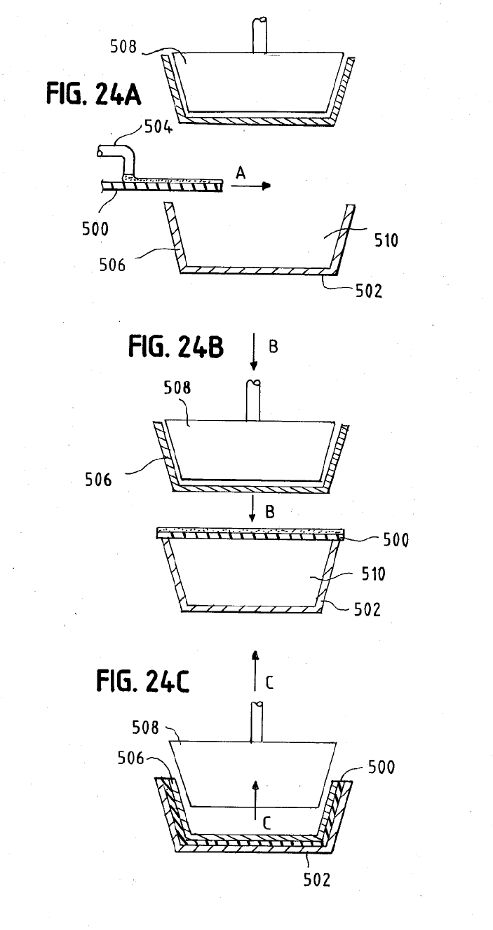

Referring to FIGS. 24A-C, a process is shown for producing a container having a label with microwave-reflection or shielding applied to the container in a mold, but not at the same time the container is formed. A continuous or separate film or label 500 can be placed over an opening of a mold 502, where the mold 502 has a general shape of a container part such as a base or one compartment, however, it is slightly larger than the desired container part in order to accommodate a preformed container 506 inserted into the mold 502. As the label 500 is being positioned over the mold 502, in the direction of arrow A shown in FIG. 24A, an adhesive element, such as glue, can be applied in-line on the label 500 via a glue source 504 so that an upper surface of the label 500 is at least partially covered with glue, as shown in FIG. 24A. Alternatively, the glue or other adhesive element may be placed on the container 506 rather than on the label 500, or still alternatively, both may contain an adhesive. Optionally, the label may also be attached to the container material 506 by mechanical means. The label does not have to be attached over its entire expanse to the container. For example, the label may be adhered only along its edges or sidewalls.

The container 506 is positioned on a plunger 508, where the plunger 508 is shaped similarly to the desired container shape and to match the shape of the mold 502, although the plunger 508 is slightly smaller than the mold 502. Once the container 506 is positioned around the plunger 508 it can be positioned above the blank 500 and the mold 502 and advanced in a direction towards the blank 500 and mold 502, as shown by the direction of arrow B in FIG. 24B. The plunger 508 can be advanced such that it is inserted into the interior section 510 of the mold 502, and is received therein. However, to be inserted into the interior section 510, the plunger 508, with the preformed container thereon, first pushes the label 500 that is resting on top of the opening of the mold 502 into the mold 502 and into the interior section 510 of the mold 502. As the plunger 508 pushes the label 500 into the mold 502, the label 500 is folded and shaped around the container 506, which in turn is around the plunger 508. This brings the label 500 into contact with the exterior of the container 506 and, as a result of the adhesive placed onto the label 500, the blank 500 and the container material 506 adhere to one another. After the plunger 508 is fully inserted into the mold 502, such that the plunger 508 is adjacent the walls of the mold 502 and the label 500 and the container 506 are adhered to each other, the plunger 508 is retreated in the opposite direction, according to the direction shown by arrow C in FIG. 24C, and removed from the mold 502. Finally, the finished container part can be removed from the mold 502 and retains the general shape of the mold 502, while the label 500 and the container material 506 remain in adherence to one another forming the layers of the container part. In some cases, the process may be assisted using vacuum applied in the mold and/or on the plunger.

The container material 506 may comprise plastic, paperboard or cardboard, among other suitable materials. Materials for the label 500 may comprise plastic, paper or aluminum, among other suitable materials. Other variations of the disclosed process are possible. For example, the label 500 can be placed on the inside of the container, such that the container 506 would push through the mold 502 opening first and the label 500 would follow, adhering to the upper surface of the container 506. Another option is for susceptors to be incorporated with the label. Furthermore, the label may only partially cover the outer (or inner) surface of the container, if partial shielding is desired. Additionally, the label can be placed on the lid of the container instead of or in addition to the container part using a similar process. Any number of labels can be used for one container, where each label can cover a portion, therefore one or more label can be incorporated into the container part in the fashion discussed above. Alternatively, a label can also be inserted between two mating containers or container parts, or between two container material layers.

From the foregoing, it will be appreciated a multi-compartment microwaveable food container is provided that allows for microwave heating of one or more food products with different energy and heating requirements to be heated together in a microwave oven at the same temperature for the same time setting. However, the disclosure is not limited to the aspects and embodiments described hereinabove, or to any particular embodiments. Various modifications to the multi-compartment microwaveable food container can result in substantially the same container.

1. A cooking apparatus for use in microwave cooking of a food product, the cooking apparatus comprising:
a container having at least a first enclosed compartment and a second enclosed compartment;
a hinge of the container; and
an in-mold label disposed on the container, the in-mold label including microwave-reflective areas corresponding to preselected areas of the container to provide shielded container zones.

2. The cooking apparatus of claim 1 wherein the hinge of the container connects the first and second compartments such that the compartments can be arranged in a stacked configuration.

3. The cooking apparatus of claim 1 further comprising a lid associated with a corresponding one of the first and second compartments and wherein the hinge of the container connects the lid to the corresponding compartment.

4. The cooking apparatus of claim 1 wherein the container further comprises a lid disposed on the first compartment to enclose the compartment.

5. The cooking apparatus of claim 4 further comprising a film seal layer disposed on the second compartment to enclose the compartment.

6. The cooking apparatus of claim 4 wherein the in-mold label is disposed on the lid.

7. The cooking apparatus of claim 1 wherein the in-mold label is disposed on at least one of the first and second compartments.

8. The cooking apparatus of claim 1 wherein at least one of the compartments has a generally bowl-shaped configuration.

9. The cooking apparatus of claim 1 wherein at least one of the compartments has a generally rectilinear configuration.

10. The cooking apparatus of claim 1 wherein the first and second compartments are arranged in a stacked configuration.

11. The cooking apparatus of claim 1 wherein the first and second compartments are arranged in a side-by-side configuration.

12. The cooking apparatus of claim 1 wherein the first compartment contains a bread-based food product and the second compartment contains a food product which is a liquid at room temperature.

13. The cooking apparatus of claim 1 wherein the first compartment comprises a bowl and the second compartment comprises an inverted bowl configured to mate with the bowl, the bowl and the inverted bowl being connected by the hinge.

14. A cooking apparatus for use in microwave cooking of a food product, the cooking apparatus comprising:
a container having at least a first enclosed compartment containing a first food product and a second enclosed compartment containing a second food product, the second enclosed compartment arranged in a stacked configuration with the first enclosed compartment; and
shielding disposed on the container, the shielding including microwave-reflective areas corresponding to preselected areas of the container to provide shielded container zones.

15. The cooking apparatus of claim 14 wherein the first and second enclosed compartments are connected by a hinged common edge.

16. The cooking apparatus of claim 14 wherein the container further comprises a lid disposed on the first compartment to enclose the first compartment.

17. The cooking apparatus of claim 16 wherein the shielding is disposed on the lid.

18. The cooking apparatus of claim 16 further comprising a film seal layer disposed on the second compartment to enclose the second compartment.

19. The cooking apparatus of claim 18 wherein the film seal layer and the lid are positioned in mating contact when the first and second compartments are in the stacked configuration.

20. The cooking apparatus of claim 18 wherein the second compartment is positioned below the first compartment in the stacked configuration.

21. The cooking apparatus of claim 18 wherein the first compartment contains a bread-based food product and the second compartment contains a product that is liquid at room temperature.

22. The cooking apparatus of claim 14 wherein the shielding is disposed on at least one of the first and second compartments.

23. The cooking apparatus of claim 14 wherein the first compartment comprises a bowl and the second compartment comprises an inverted bowl configured to mate with the bowl and having a rectilinear recess therein.

24. A cooking apparatus for use in microwave cooking of a food product, the cooking apparatus comprising:
a container having multiple compartments arranged in side-by-side configuration;
a lid disposed on and substantially covering at least one of the multiple compartments;
an in-mold label disposed on the lid, the in-mold label including microwave-reflective areas to provide at least one shielded container zone corresponding to at least one of the multiple compartments; and
one or more lid clips extending to secure the lid to the container.

25. The cooking apparatus of claim 24 wherein the container is generally rectilinear and comprises three compartments.

26. The cooking apparatus of claim 24 wherein the one or more lid clips comprise resilient projections extending over the lid when the lid is disposed on the container.
